(19) United States
(12) Patent Application Publication
(10) Pub. No.: US 2013/0098949 A1
(43) Pub. Date: Apr. 25, 2013

(54) ICE CHUTE ARRANGEMENT

(71) Applicants: Albert Dirnberger, Neunburg (DE); Matthias Bauer, Schmidgaden (DE); Christian Rittner, Weiden (DE)

(72) Inventors: Albert Dirnberger, Neunburg (DE); Matthias Bauer, Schmidgaden (DE); Christian Rittner, Weiden (DE)

(73) Assignee: EMZ-HANAUER GMBH & CO. KGAA, Nabburg (DE)

(21) Appl. No.: 13/280,680

(22) Filed: Oct. 25, 2011

(51) Int. Cl. B67D 3/00; B67D 7/08

(52) U.S. Cl. 222/517; 222/505

(57) ABSTRACT

An ice chute arrangement that includes a fixed frame adjacent to an ice passageway. A flap is pivotal upon the frame between a first flap position and a second flap position. The flap blocks the ice passageway when the flap is in the first position, reveals the passageway when the flap is in the second position and transitions through an intermediate position. The arrangement includes a paddle pivotal upon the frame between a first position and a second position. The paddle causes the flap to pivot from the first position to the second position as the paddle pivots from the first position to the second position. The arrangement includes a first spring that biases the flap toward the first flap position while the flap is in the first flap position and biases the flap toward the second flap position while the flap is in the second flap position.

### FIELD OF THE INVENTION

The present application relates generally to ice chutes for delivering ice pieces from a freezer section, and specifically relates to an ice chute that has a preferable manual actuation force profile.

### BACKGROUND OF THE INVENTION

Ice chute devices provide for delivery of ice pieces, such as ice cubes and/or ice chips, from a freezer section of a refrigerator device to ambient atmosphere. Typically, such delivery is into a cup or the like when an actuation paddle is pushed. Also, the ice chute devices have a flap to close and block a passageway between the freezer section and ambient atmosphere when ice pieces are not being delivered. Paddle actuation causes the flap to move from the closed position to an open position for ice piece delivery.

A known ice chute device can use a single spring to bias the flap into the closed position. However, the spring force must be sufficient to maintain the flap in the closed position, but yet not be so large that paddle actuation force is unfavorably large.

Another known ice chute device can use an electrical component, such as a motor, to move the flap when the paddle is actuated. However, inherently, complication and cost for such a device are higher than a device that only contains mechanical components.

As such, there is a need for improvements in ice chute technologies to address the issues of cost moderation and satisfactory user operation parameters.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with one aspect, the present invention provides an ice chute arrangement that includes a fixed frame for fixed location adjacent to a passageway between a freezer section and ambient atmosphere. The arrangement includes a flap pivotally mounted upon the fixed frame for pivot movement between a first flap position and a second flap position. The flap blocks the passageway between the freezer section and ambient atmosphere when the flap is in the first flap position. The flap reveals the passageway and permits passage of ice pieces through the passageway when the flap is in the second flap position. The flap transitions through an intermediate flap position located between the first and second paddle positions. The arrangement includes a paddle pivotally mounted upon the fixed frame for pivot movement between a first paddle position and a second paddle position. The paddle causes the flap to pivot from the first flap position to the second flap position as the paddle pivots from the first paddle position to the second paddle position. The arrangement includes a first spring that biases the flap toward the first flap position while the flap is within a range extending between the first flap position and the intermediate flap position and biases the flap toward the second flap position while the flap is within a range extending between the intermediate flap position and the second flap position.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 perspective illustration of an example ice chute arrangement in accordance with an aspect of the present invention;

FIG. 2 is a side view of the ice chute arrangement of FIG. 1 and shows a flap of the arrangement in a first flap position, a paddle of the arrangement in a first paddle position, and a first spring providing a first bias force;

FIG. 3 is a view similar to the view of FIG. 2, but shows the flap of the arrangement in a second flap position and the paddle of the arrangement in a second paddle position, and the first spring providing a second, different bias force; and

FIG. 4 is a forward view of the ice chute arrangement of FIG. 1.

### DESCRIPTION OF EXAMPLE EMBODIMENTS

An example embodiment of a device that incorporates aspects of the present invention is shown in the drawings. It is to be appreciated that the shown example is not intended to be a limitation on the present invention. For example, one or more aspects of the present invention can be utilized in other embodiments and even other types of devices.

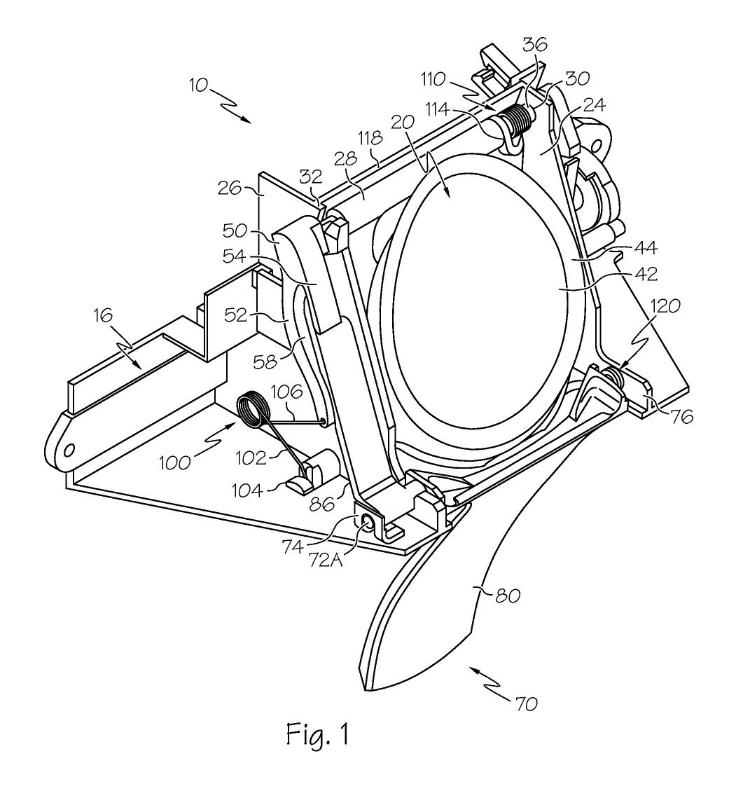

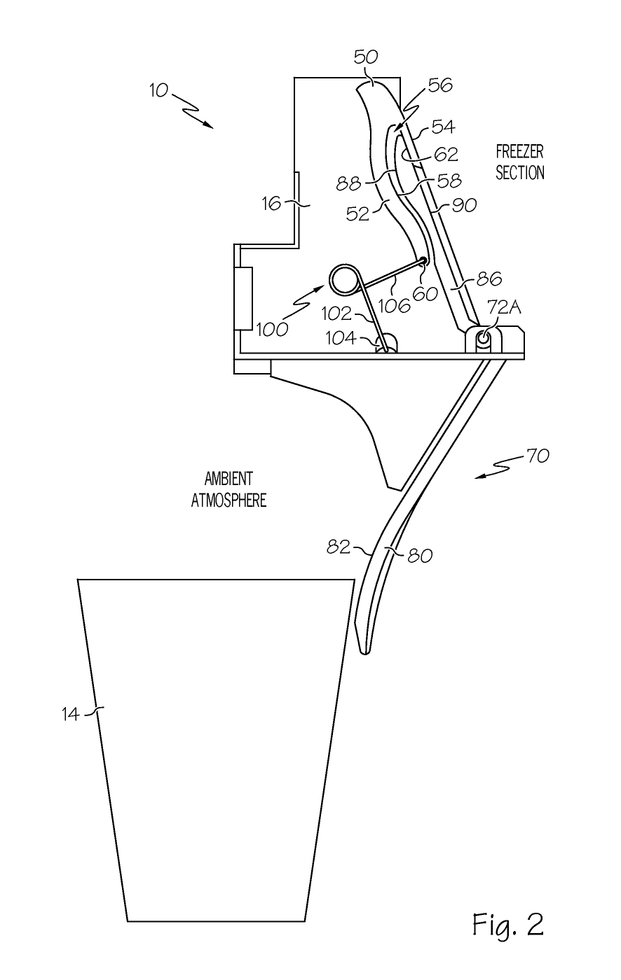

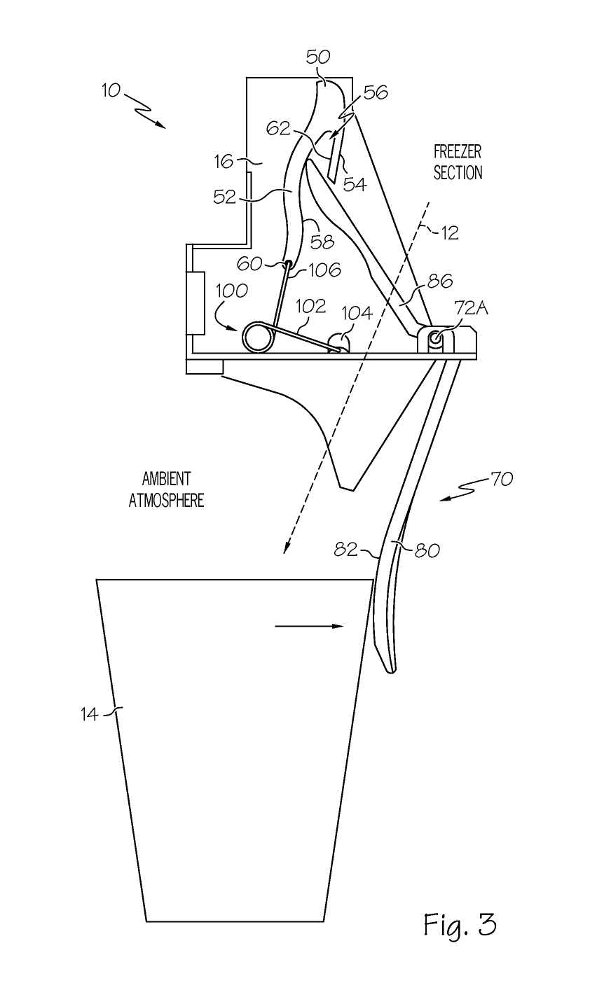

FIG. 1 shows an example ice chute arrangement 10 in accordance with an aspect of the present invention. It is to be appreciated that the ice chute arrangement 10 can be utilized in conjunction with a refrigerator with a freezer section (see FIG. 2) which has a supply of ice pieces (i.e., ice cubes and/or ice chips), which can be dispensed from the refrigerator via the ice chute arrangement 10. The ice pieces are stored within the freeze section of the refrigerator and can be delivered, via a mechanism within the refrigerator such as an auger/pusher/crusher, to the ice chute arrangement 10 and proceed from the freezer section of the refrigerator to the ambient atmosphere which surrounds the refrigerator. The refrigerator has a passageway (e.g., an opening or aperture) 12 (FIG. 3) that is between the freezer section and the ambient atmosphere. Also, the ice pieces are typically dispensed into a container such as a cup 14 (FIG. 2) as the ice pieces move from the freezer section via the ice chute arrangement 10. It is to be appreciated that the specific details of the refrigerator, the freezer section, the ice pieces, the ambient atmosphere, and the container (e.g., cup 14), are not specific limitations upon the present invention. Also, it is to be appreciated that the example ice chute arrangement 10 shown in FIG. 1 need not be a specific limitation upon the present invention and that the ice chute arrangement 10 can have modification, adaptions, and the like to be used within different environments that have variations on the refrigerator, the freezer section, the ice pieces, the ambient atmosphere, and the container (e.g., cup 14).

It is also to be appreciated that the ice chute arrangement 10 may be associated with the dispensing of water and specifically water chilled from within the associated refrigerator. One or more of the components to be described herein may be utilized for the dispensing of the water. However, as will be understood upon an appreciation of the present invention, the present invention relates more to dispensing of ice pieces. As such, details of configuring/constructing some or all of the ice chute arrangement 10 to also be associated with dispensing of water are not presented herein. Of course, it is to be appreciated that such configuring/constructing of some or all of the ice chute arrangement 10 to also be associated with dispensing of water can be varied dependent upon application. Also, it is to be appreciated that such configuring/constructing of some or all of the ice chute arrangement 10 to also be associated with dispensing of water need not be specific limitations upon the present invention.

The ice chute arrangement 10 includes a fixed frame 16 for fixed location on the refrigerator/freezer section adjacent to the passageway 12 between the freezer section and the ambient atmosphere. The fixed frame 16 is fixed relative to the refrigerator/freezer section. For example, the fixed frame 16 may be fixed relative to a door or other portion of the refrigerator adjacent to the freezer section. The fixed frame 16 may have any suitable mounting structure, connections, sensors etc. Such structural features and aspects need not be present and certainly do not form part of the present invention. As such, the fixed frame 16 shown within the drawings and described herein is presented with somewhat generic features and thus there should be an appreciation that the appearance, structure, etc. of the fixed frame 16 can be varied from that shown and described herein.

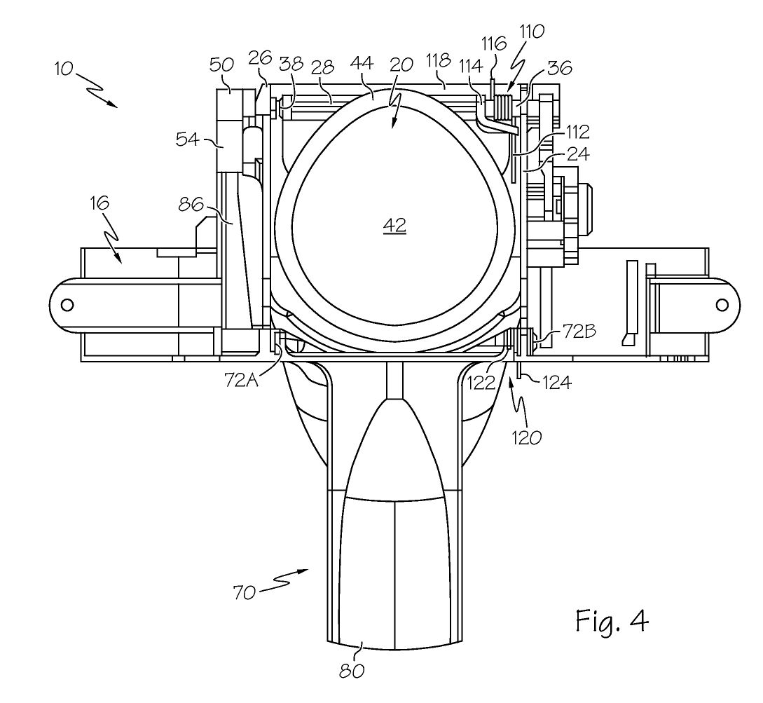

A flap 20 (FIGS. 1 and 4) of the ice chute arrangement 10 is pivotally mounted upon the fixed frame 16. Specifically, the shown example of the fixed frame 16 and flap 20 includes portions 24, 26 of the fixed frame that provides support for a pivot axle 28 of the flap 20. Within the shown example, the portions 24, 26 of the fixed frame 16 for pivot support includes a portion 24 having a hole 30 and another portion 26 providing a saddle 32. A first end 36 of the pivot axle 28 of the flap 20 is pivotally supported within the hole 30 and a second end 38 of the pivot axle 28 is pivotally supported within the saddle 32. Within the shown example, the pivot location of the flap 20 is at an upper end of the flap. The flap 20 is pivotable through a range of positions between first flap position (shown in FIGS. 1 and 4, and also associated with FIG. 2 but with a majority of the flap 20 obscured by the fixed frame 16) and a second flap position (shown in FIG. 3).

The flap 20 includes a main body 42 that is shaped and configured to be generally complimentary to the passageway 12 that extends between the freezer section and the ambient atmosphere. In the shown example, the main body 42 has a general disk shape. The main body 42 certainly may have a different shape and configuration from that which is shown within the drawings. Also, within the shown example, the flap 20 includes a seal 44 which is made of resilient material and can engage against a surface of the refrigerator/freezer compartment to seal the passageway 12 when the flap 20 is in the first flap position (FIGS. 1, 2 and 4) which is a closed/sealing position. The flap 20, and specifically the main body 42/seal 44, blocks the passageway 12 between the freezer section and the ambient atmosphere when the flap is in the first flap position (FIGS. 1, 2 and 4). The main flap body 42/seal 44 reveals or opens the passageway 12 and permits passage of ice pieces through the passageway when the flap 20 is in the second flap position.

Within the shown example, the pivot location of the flap 20 is above the main body 42 and seal 44. As such, the main body 42 and seal 44 pivot clockwise when taken in the context of a comparison of FIGS. 2 and 3. So in the example, the main body 42 and seal 44 can be considered to pivot out from the freezer section and/or up from the path that the ice pieces will proceed along the passageway 12 heading toward the container (e.g., cup) 14.

The flap 20 includes a flap arm 50. Within the shown example, the flap arm 50 is located on one end of the flap pivot axle 28 (see FIG. 1). Specifically, within the shown example, the flap arm 50 is located on a side of the portion 26 of the fixed frame 16 opposite to the side of the main body 42 of the flap 20. As such, the saddle 32 of the fixed frame 16 is located between the main flap body 42 and the flap arm 50. The flap arm 50 is fixed to the rest of the flap 20 so as to pivot with the rest of the flap 20. Specifically, the flap arm 50 pivots contemporaneously with the pivoting of the main flap body 42.

Within the shown example, the flap arm 50 is bifurcated to have a plurality (e.g., two) fingers 52, 54. In the shown example, the two fingers 52, 54 extend generally downward from the point of connection of the flap arm 50 to the flap pivot axle 28 (see FIG. 1). An entrapment area 56 is located between the two, spaced apart fingers 52, 54. A first (e.g., 52) of the fingers is relatively elongate and arcing to have a curved cam surface 58. The curved cam surface 58 of the first finger 52 faces into the entrapment area 56. A distal end of the first finger 52 has a spring-end retaining hole 60. The second finger 54 of the shown example is generally straight and relatively shorter as compared to the first finger 52. The second finger 54 has an engagement surface 62 that faces into the entrapment area 56. As orientation reference and as can be seen in FIG. 2, the first finger 52 is generally closer to/extends toward the location of the cup 14 in the ambient atmosphere and the second finger 54 is generally closer to the freezer section.

The ice chute arrangement 10 includes a paddle 70 that is pivotally mounted upon the fixed frame 16. Specifically, the paddle has at least one, but in the presented example two, pivot axles 72A, 72B (see FIG. 4). The pivot axles 72A, 72B are actually coaxial axle segments. It is easily appreciated that the paddle 70 could be configured to have a single axle extending across its width. The pivot axles 52A, 72B are each pivotally supported and retained within respective retainer portions 74, 76 on the fixed frame 16. Within the shown example, the pivot location of the paddle 70 can be considered to have an intermediate location of the paddle with regard to all of the constituent parts of the paddle 70. The paddle 70 is pivotable through a range of positions between a first paddle position (shown in FIGS. 1, 2 and 4) and a second paddle position (shown in FIG. 3).

The paddle 70 has a generally downwardly, as compared to the paddle pivot location, extending lever or tongue 80. The tongue 80 is fixed for pivot movement with the rest of the paddle 70. Specifically, as the paddle 70 pivots, the tongue 80 contemporaneously pivots as part of the paddle 70 through the same angular range of motion. From a perspective of a user, the paddle tongue 80 can be considered to be at a location on a distal side of the path that ice will travel upon proceeding through the passageway 12. The paddle tongue 80 can certainly have variation on length and width. Often such length and width are based upon surrounding structure of the refrigerator. The tongue 80 can be engaged and moved (see movement arrowhead in FIG. 3), such as on surface 82, by a user or an object, such as the cup 14, held by the user to cause pivoting of the paddle 70 from the first paddle position (FIG. 2) toward the second paddle position (FIG. 3).

The paddle 70 has a generally upwardly, as compared to the paddle pivot location, extending a paddle arm 86. The paddle arm 86 is fixed for pivot movement with the rest of the paddle 70. Specifically, as the paddle 70 pivots, the paddle arm 86 contemporaneously pivots as part of the paddle 70 through the same angular range of motion.

Within the shown example, the paddle arm 86 is a single member connected to the rest of the paddle 70 at one of the pivot axles (e.g., 72A) of the paddle 70. As compared to the paddle tongue 80, the paddle 70 is located above the tongue and extends generally upward from the location of the tongue. The paddle arm 86 extends into the entrapment area 56 defined by the two fingers 52, 54 of the flap arm 50. The paddle arm 86 has a curved cam surface 88 that can engage against the curved cam surface 58 of the first finger 52 of the flap arm 50. Also, the paddle arm 86 includes an engagement surface 90 that can engage against the engagement surface 62 of the second finger 54 of the flap arm 50.

Forces can be transmitted between the paddle arm 86 of the paddle 70 and the flap arm 50 of the flap 20. Thus, forces can be transmitted between the paddle 70 and the flap 20. For example, the paddle arm 86 of the paddle 70 can cause pivot movement of the flap 20 in a direction from the first flap position (FIG. 2) toward the second flap position (FIG. 3). Specifically, the cam surface 88 on the paddle arm 86 can bear against and push the cam surface 58 of the first finger 52 of the flap arm 50. Also, the paddle arm 86 of the paddle 70 can cause pivot movement of the flap 20 in a direction from the second flap position (FIG. 3) toward the first flap position (FIG. 2). Specifically, the engagement surface 90 on the paddle arm 86 can bear against and push the surface 62 of the second finger 54 of the flap arm 50. Of course, force(s) can also be transmitted back from the flap arm 50 of the flap 20 to the paddle arm 86 of the paddle 70.

The ice chute arrangement 10 includes a resilient first spring 100. The first spring 100 within the shown example is a torsion spring and has one end 102 extending/entrapped into a portion 104 on the fixed frame 16 and a second end 106 extending/entrapped into the hole 60 on the first finger 52 of the flap arm 50. The first spring 100 can provide spring bias force against the flap 20, via the flap arm 50, to cause movement of the flap and retention of the flap as described further below.

The ice chute arrangement 10 includes a resilient second spring 110 for biasing the flap 20 in a pivot direction toward the first flap position (FIG. 2). Within the shown example, the second spring 110 is a torsion spring that is mounted on/about the flap pivot axle 28. One end 112 (see FIG. 4) of the second spring 110 is held/entrapped by a hook 114 of the flap 20. A second end 116 of the second spring 110 engages/blocks against a portion 118 of the fixed frame 16.

The ice chute arrangement 10 includes a resilient third spring 120 (see FIGS. 1 and 4) for biasing the paddle 70 in a pivot direction toward the first paddle position (FIG. 2). Within the shown example, the third spring 120 is a torsion spring mounted upon one of the pivot axles (e.g., 72B) of the paddle 70. One end 122 (see FIG. 4) of the third spring 120 is engaged/entrapped by a portion of the paddle 70 and a second end 124 of the third spring 120 bears is engaged/entrapped by a portion of the fixed frame 16 (these portions are only minimally visible in FIG. 4, but such are generally similar to that of the second spring 110).

Returning focus upon the first spring 100, attention is directed to a comparison of FIGS. 2 and 3. It should be noted that the first spring 100, and specifically the connection locations/interactions of the first spring 100 with the fixed frame 16 and the flap arm 50, is such that the first spring 100 will provide biasing forces in different directions dependent upon the position of the flap 20/flap arm 50 relative to the fixed frame 16. Specifically, with reference to FIG. 2, the first spring 100 provides a biasing force that urges the flap 20/flap arm 50 into/toward the first position while the flap 20/flap arm 50 is in the first position (FIG. 2) and positions adjacent thereto. With reference to FIG. 3, the first spring 100 provides a biasing force that urges the flap 20/flap arm 50 into the second flap position (FIG. 3) while the flap 20/flap arm 50 is in the second flap position and positions adjacent thereto.

It is to be appreciated that the flap 20/flap arm 50 will move through an intermediate or transition position, located between the first and second flap positions, at which the first spring 100 will change or transition its bias orientation. So, in general, the first spring 100 biases the flap 20 toward the first flap position while the flap is within a range extending between the first flap position and the intermediate flap position and biases the flap toward the second flap position while the flap is within a range extending between the intermediate flap position and the second flap position. In the shown example, this transition will occur when the first spring 100 has its greatest resilient deformation (i.e., greatest torsion), with the two ends 102 and 104 of the first spring 100 being at a smallest separating distance from each other. Thus, the first spring 100 can be considered to be an over-center spring and the position/condition of the first spring 100 at the transition being the over-center point. Thus, for the first spring 100, the intermediate or transition position of the flap 20 has a correspondence to the over-center point of the first spring 100. Once the first spring 100 operates/travels past the over-center point, the bias spring force provide by the first spring against the flap changes (i.e., reverses). Associated with this transitioning is the movement of the paddle through its own intermediate or transition position, which is between the first and second paddle positions. Thus, there is a three-way correspondence among the over-center point of the first spring 100, the intermediate position of the flap 20 and the intermediate position of the paddle 70.

During operation, with the flap 20 in the first flap position (FIG. 2) and the paddle in the first paddle position (FIG. 2), the first spring 100 biases the flap into the first flap position (FIG. 2). Thus, the flap 20 blocks the passageway 12 between the freezer section and the ambient atmosphere. Also, the second spring 110 biases the flap 20 into the first flap position (FIG. 2). Recall that the second spring 110 always biases the flap 20 toward the first flap position (FIG. 2). Further, the third spring 120 biases the paddle 70 into the first paddle position (FIG. 2). Recall that the third spring 120 always biases the paddle 70 toward the first paddle position (FIG. 2).

It is to be appreciated that because of the engagement surfaces 90 and 62 on the paddle arm 86 and the second finger 54 of the flap arm 50, the biasing force from the third spring 120 can also be transmitted through the paddle 70 and specifically the paddle arm 86, to also urge the flap 20 into the first flap position (FIG. 2). Thus, the overall force which holds the flap 20 in the first flap position (FIG. 2) can be provided by multiple springs (e.g., two or three springs). At least the first spring 100, and the second spring 110, and possibly the third spring 120 are providing constituent parts of the overall biasing force.

However, when the positioning of the flap 20 and the paddle 70 are moved from their respective first positions, past their respective intermediate transition positions, the first spring 100 changes to bias the flap 20 toward the second flap position (FIG. 3). As such, the first spring 100 is acting in opposition against the second spring 110 with regard to providing bias against the flap 20. The paddle 70/third spring 120, can provide force urging the flap 20 toward the second flap position (FIG. 3) or the first flap position (FIG. 3) dependent upon whether an operator is pushing (e.g., directly or with an object such as a cup 14) on to the paddle 70.

Accordingly, a very useful force profile is provided by the ice chute arrangement 10. When the paddle 70 and thus the flap 20 move from their respective first positions past their intermediate transition positions, the force required by the operator for continued movement/holding, and thus receive ice pieces from the freezer section, is lessened as compared to an arrangement in which a spring force or compound spring force does not transition/change. Also, because multiple springs (e.g., 100, 110 and 120) are providing respective biasing forces while the flap 20 is in the first position (FIG. 2), smaller spring forces can be provided from each individual spring (e.g., 100, 110 and 120).

The invention has been described with reference to the example embodiments described above. Modifications and alterations are possible and/or will occur to others upon a reading and understanding of this specification. For example, if ice chute arrangement is used in conjunction with dispensing of water it is contemplated that sensors, electrical switches or the like could be utilized to selectively control mode (e.g., ice dispensing or water dispensing) of operation. Along the lines of such association with such selective water dispensing, mode control can be done via sensing of paddle movement/position, timing of movements/held position durations, or the like. Other examples embodiments incorporating one or more aspects of the invention are intended to include all such modifications and alterations insofar as they come within the scope of the appended claims.

What is claimed is:

1. An ice chute arrangement including:
a fixed frame for fixed location adjacent to a passageway between a freezer section and ambient atmosphere;
a flap pivotally mounted upon the fixed frame for pivot movement between a first flap position and a second flap position, the flap blocking the passageway between the freezer section and ambient atmosphere when the flap is in the first flap position, the flap revealing the passageway and permitting passage of ice pieces through the passageway when the flap is in the second flap position, the flap transitioning through an intermediate flap position located between the first and second paddle positions;
a paddle pivotally mounted upon the fixed frame for pivot movement between a first paddle position and a second paddle position, the paddle causing the flap to pivot from the first flap position to the second flap position as the paddle pivots from the first paddle position to the second paddle position; and
a first spring biasing the flap toward the first flap position while the flap is within a range extending between the first flap position and the intermediate flap position and biasing the flap toward the second flap position while the flap is within a range extending between the intermediate flap position and the second flap position.

2. An ice chute arrangement as set forth in claim 1, wherein the first spring has one end connected to the fixed frame and another end connected to the flap.

3. An ice chute arrangement as set forth in claim 1, wherein the first spring is connected to act as an over-center spring and has an over-center point associated with the flap being in the intermediate flap position.

4. An ice chute arrangement as set forth in claim 1, wherein the first spring is a torsion spring.

5. An ice chute arrangement as set forth in claim 1, wherein flap includes a flap arm and the paddle includes a paddle arm, during pivoting of the paddle the paddle arm causes movement of the flap arm and pivot the flap.

6. An ice chute arrangement as set forth in claim 5, wherein the flap arm has a curved cam surface and the paddle arm has a curved cam surface, the cam surface of the paddle arm moves relative to the cam surface of the flap during pivot movement of the paddle.

7. An ice chute arrangement as set forth in claim 6, wherein at least one of the flap arm and paddle arm is bifurcated to have two fingers between which the other of the flap arm and paddle arm is located, the paddle arm can transmit a force to the flap arm that urges the flap toward the first flap position and the paddle arm can transmit a force to the flap arm that urges the flap toward the second flap position.

8. An ice chute arrangement as set forth in claim 7, wherein the flap arm is bifurcated to have two fingers between which the paddle arm is located.

9. An ice chute arrangement as set forth in claim 1, further including a second spring biasing the flap toward the first flap position.

10. An ice chute arrangement as set forth in claim 9, wherein with the flap in the first flap position both the first and second springs urge the flap to remain in the first flap position; and with the flap in the second flap position the first spring urges the flap to remain in the second flap position and the second spring urges the flap toward the first flap position.

11. An ice chute arrangement as set forth in claim 9, further including a third spring biasing the paddle toward the first paddle position.

12. An ice chute arrangement as set forth in claim 11, wherein the flap and the paddle have cooperating portions transmitting force between the flap and the paddle, with the paddle in the first paddle position the cooperating portions transmitting a force proceeding from the third spring that urges the flap to remain in the first flap position.
